(19) United States
(12) Patent Application Publication
(10) Pub. No.: US 2013/0070761 A1
(43) Pub. Date: Mar. 21, 2013

(54) SYSTEMS AND METHODS FOR CONTROLLING A NETWORK SWITCH

(71) Applicants: Keshav Govind Kamble, Fremont, CA (US); Vijoy A. Pandey, San Jose, CA (US); Dar-Ren Leu, San Jose, CA (US); Jayakrishua Kidambi, San Jose, CA (US); Dayavanti G. Kamath, Santa Clara, CA (US); Amitabha Biswas, San Francisco, CA (US); Nilanjan Mukherjee, Santa Clara, CA (US)

(72) Inventors: Keshav Govind Kamble, Fremont, CA (US); Vijoy A. Pandey, San Jose, CA (US); Dar-Ren Leu, San Jose, CA (US); Jayakrishua Kidambi, San Jose, CA (US); Dayavanti G. Kamath, Santa Clara, CA (US); Amitabha Biswas, San Francisco, CA (US); Nilanjan Mukherjee, Santa Clara, CA (US)

(73) Assignee: INTERNATIONAL BUSINESS MACHINES CORPORATION, Armonk, NY (US)

(21) Appl. No.: 13/237,143

(22) Filed: Sep. 20, 2011

(51) Int. Cl. H04L 12/56

(52) U.S. Cl. 370/389

(57) ABSTRACT

Systems and methods are provided for controlling a network switch. At least one forwarding element of the distributed switch is positioned at a first location of a network. A control element of the distributed switch is positioned at a second location of the network. The at least one forwarding element is controlled from the control element by establishing a communication between the forwarding element and the control element via the network.

### FIELD OF THE INVENTION

The present inventive concepts relate generally to data networking. More particularly, the present inventive concepts relate to a remote server-based control plane for a network switch.

### BACKGROUND

Data centers are generally centralized facilities that provide Internet and intranet services needed to support businesses and organizations. A typical data center can house various types of electronic equipment, such as computers, servers (e.g., email servers, proxy servers, and DNS servers), switches, routers, data storage devices, and other associated components. The infrastructure of the data center, specifically, the layers of switches in the switch fabric, plays a central role in the support of the services. Interconnection among the various switches can be instrumental to scalability, that is, the ability to grow the size of the data center

Each switch includes a controller that controls the switch functions, for example, packet processing, forwarding, and the like. In configurations comprising a large number of network switch ports per switch or a cluster of switches under a single data plane domain, the computing power requirements for a switch controller is high.

### SUMMARY

In one aspect, a method is provided for controlling a network switch. At least one forwarding element of the distributed switch is positioned at a first location of a network. A control element of the distributed switch is positioned at a second location of the network. The at least one forwarding element is controlled from the control element by establishing a communication between the forwarding element and the control element via the network.

In another aspect, a network switch comprises a forwarding element and a control element. The forwarding element is connected to a network. The forwarding element receives and forwards data packets via the network. The control element is at a physically separate location from the forwarding element and in communication with the forwarding element via the network. The control element controls the forwarding element via communication path between the control element and the forwarding element via the network.

In another aspect, a method is provided for remotely controlling a forwarding element of a network switch. A data packet is received at a data port of the forwarding element. The data packet is output to a DC layer of the forwarding element. The data packet is output from the DC layer of the forwarding element to the DC layer of a control element at a remote server. The data packet is output from the DC layer of the control element to an application layer at the control element.

In another aspect, a computer program product is for controlling a network switch. The computer program product comprises a computer readable storage medium having computer readable program code embodied therewith. The computer readable program code comprises computer readable program code configured to provide at least one forwarding element of the distributed switch at a first location of a network. The computer readable program code further comprises computer readable program code configured to provide a control element of the distributed switch at a second location of the network. The computer readable program code further comprises computer readable program code configured to control the at least one forwarding element from the control element by establishing a communication between the forwarding element and the control element via the network.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of an environment in which embodiments of the present inventive concepts can be employed;

FIG. 2 is a detailed block diagram of the master control element, the backup control element, and two forwarding elements of FIG. 1 including connections therebetween, in accordance with an embodiment;

FIG. 3 is a flowchart of a method for providing a remote server-based control plane for a network switch, in accordance with an embodiment; and

FIG. 4 is another block diagram of FIG. 2 illustrating a data flow path formed between components of the control elements and the forwarding elements, in accordance with an embodiment.

### DETAILED DESCRIPTION

In the following description, specific details are set forth although it should be appreciated by one of ordinary skill that the systems and methods can be practiced without at least some of the details. In some instances, known features or processes are not described in detail so as not to obscure the present invention.

Conventional switches, including stacked switches, virtual switches, distributed chassis switches, line cards, or other network elements include a switch controller that is closely integrated with the packet forwarding functionality of the switch under the same hardware platform. However, modern network switches typically provide virtual port capabilities, requiring additional processing resources for the controller. The computing power requirements are particularly important when multiple switches are grouped together to form a distributed virtual switch having a large number of virtual ports.

In brief overview, the control elements (CE) and forwarding elements (FE) of a network switch are separated from each other, such that the control element executes on a remote server or other different hardware device than the FE hardware device. Accordingly, the FE hardware device does not require additional computing resources, for example, a more powerful CPU, when a port density increase occurs in a data plane domain. The remote server having the control element can be upgraded with a required set of computing resources with no impact on the FE hardware device.

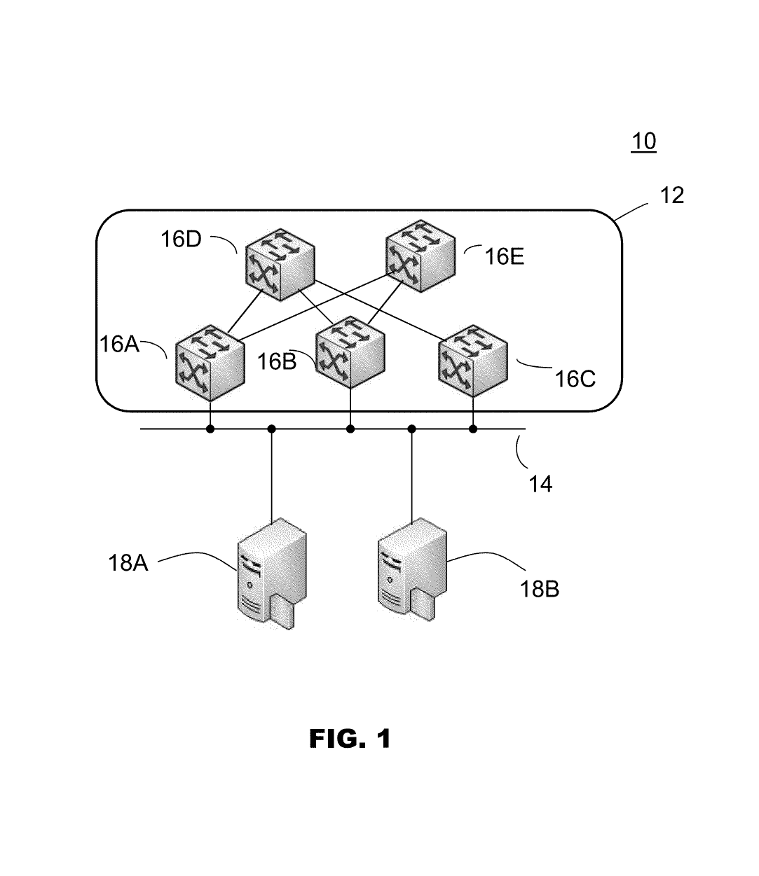

FIG. 1 is a block diagram of an environment 10 in which embodiments of the present inventive concepts can be employed. In a preferred embodiment, the environment 10 includes a data center or a related facility that provides for high network traffic volumes. The infrastructure of the data center includes a switch fabric 12, which a plurality of forwarding elements 16A-16E (generally, 16) interconnected with each other in a configuration that provides for scalability. The switch fabric 12 can be constructed according to a distributed fabric system architecture, where the forwarding elements 16A-16E are connected in a daisy chain, full mesh, star, stack, or related configuration. The switch fabric 12 can include a cell and/or packet-based switch fabric, and can include core switches, access switches, or other network elements, line cards, for example, distributed line cards, or a combination thereof. The forwarding elements 16 can be part of one or more network elements of the switch fabric 12, for example, a virtual switch, a stacked switch, a distributed switch, a cell-based switch, and the like. Accordingly, each forwarding element 16 comprises a plurality of physical and/or virtual network ports. The ports can be Ethernet ports, for example, Gigabit (GB) or 10 GB ports.

Each forwarding element 16 processes and forwards received layer 2 or layer 3 packets under the control of a master control element 18A. The master control element 18A can be a control plane for a single forwarding element 16, for example, forwarding element 16A. Alternatively, the master control element 18A can serve a plurality of forwarding elements 16. A single remote server can include a plurality of master control elements 18A, each in communication with one or more forwarding elements 16. The environment 10 can also include a backup control element 18B for redundancy, high availability, and the like. The backup control element 18B can communicate with the master control element 18A in a manner described in detail below.

The manner in selecting the master control element 18A or the backup control element 18B can be similar to regular stacking software. Users can configure which control element is the preferred master. The selected control element can be assigned a higher priority.

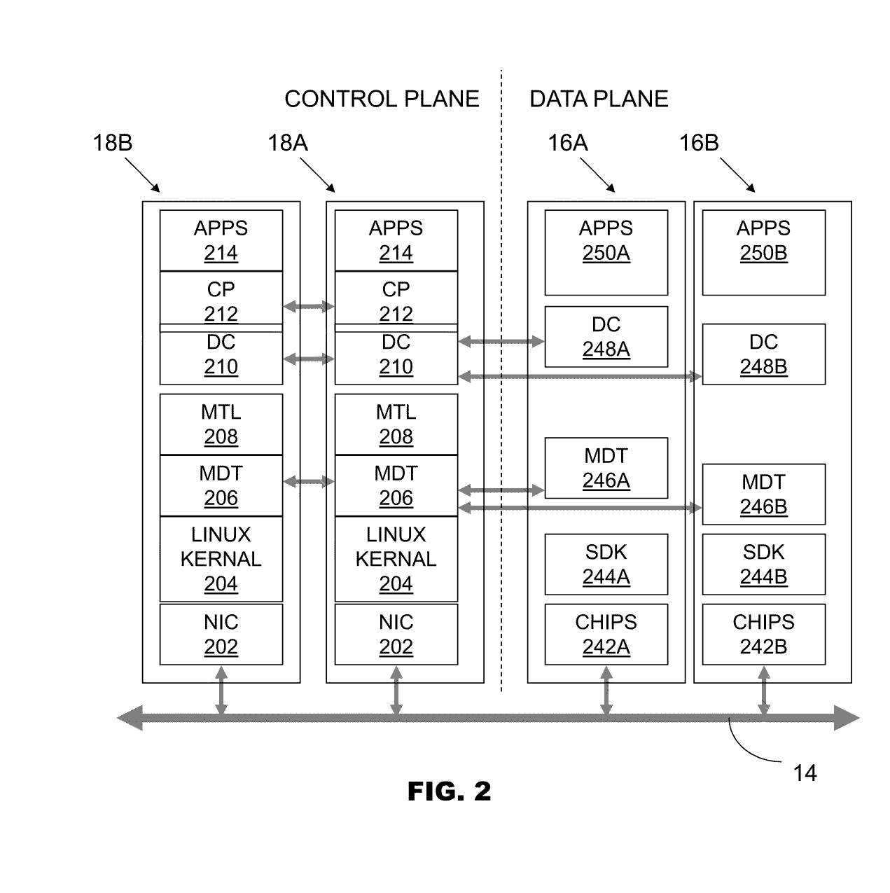

The control element 18 runs on a computer system such as a server that includes at least one processor, for example, a CPU, a network interface, and a memory in communication with each other via a system bus. The memory can include volatile memory, for example, RAM and the like. The memory can include non-volatile memory, for example, ROM, flash memory, and the like. The memory can include removable and/or non-removable storage media implemented in accordance with methods and technologies known to those of ordinary skill in the art for storing data. Stored in the memory can include program code, such as program code corresponding to an operating system executed by the processor and controlling the functions of the various components of the computer system. The program code can also correspond to elements of the control element 18 described in FIG. 2.

The network 14 can be a WAN, LAN, Internet, public network, private network, for example, an Ethernet network. In an embodiment, the network 14 is configured as an L2 VLAN, which includes the control elements 18 and the forwarding elements 16.

FIG. 2 is a detailed block diagram of the master control element 18A, the backup control element 18B, and two forwarding elements 16A, 16B of FIG. 1 including connections therebetween, in accordance with an embodiment.

Forwarding element 16A includes a set of chips 242A, a software developer kit (SDK) 244A, a member discovery and transport (MDT) layer 246A, a device configuration (DC) layer 248A, and an application layer 250A. Forwarding element 16B similarly includes a set of chips 242B, a software developer kit (SDK) 244B, a member discovery and transport (MDT) layer 246B, a device configuration (DC) layer 248B, and an application layer 250B.

The chips 242A, 242B (generally, 242) can include application-specific integrated circuits (ASICs) or other hardware circuitry and features known to those of ordinary skill in the art. For example, the chips 242 include ingress and egress logic for data plane processing, packet switching, and so on. The chips 242 include one or more ports for communicating with a network, for example, 10 GB Ethernet ports, for transmitting and receiving data, for example, data packets with other network devices. The chips 242 can include an interface, for example, a HiGig™ interface or an Ethernet interface, for communicating with other components. Additional details of the chip packet processing features are known to those of ordinary skill in the art, and are omitted herein for reasons related to brevity.

The SDKs 244A, 244B (generally, 244) comprise runtime tools such as the Linux kernel, development tools, software libraries and frameworks, and so on. Details of the SDK 244 are known to those of ordinary skill in the art, and are omitted herein for reasons related to brevity.

The MDT layers 246A, 246B (generally, 246) service the need for member discovery and reporting to the control element 18. A member can be a control element, a forwarding element, or other switch element. The MDT layers 246 can include a switch discovery protocol (SDP) module responsible for switch discovery, switch-gone detection, and the like. When switches are discovered, the SDP module can report all of the discovered switches to the local DC layer 248.

The MDT layers 246 can include an L2 transport layer, for example, a light-weight L2 transport (EL2T) layer can be provided for higher levels of the forwarding element architecture such as the DC layer 248. The MDT layers 246 permit different devices, for example, the forwarding element 16A and the control element 18A, to communicate with each other via their respective DC layers 210, 248. An MDT layer 246 can exchange data with a corresponding MDT layer 206 of the master control element 18A via the network 14.

The DC layers 248A, 248B (generally, 248) service the communications needed for the master control element 18A to control the operation of the forwarding element 16 in which the DC layers 248 are configured. The DC layers 248 are configured for tunneling packet data to the master control element 18A. A DC layer 248 can exchange data with a corresponding DC layer 208 of the master control element 18A, for example, via the MDT layer 246 and the network 14. The DC layer 248 can service the communications needed for the master control element 18A to control one or more forwarding elements 16, for example, redirecting protocol control packets from a data port of a forwarding element 16 to the master control element 18A and/or the backup control element 18B for processing. Also, the master control element 18A can output a protocol control packet to a specific data port on the forwarding element 16.

The DC layers 248 can include a DC-stacking module configured to perform stack formation on each forwarding element 16 in a same group, and communicates with a DC layer 210 of the master control element 18A, for example, via the EL2T layer, for exchanging data such as stack formation data, such that the master control element 18A keeps up-to-date information related to the forwarding elements 16.

Each forwarding element 16 can further include a stacking code, for stack and/or fabric formation and the like. The stacking code can provide a chip-to-chip interface such as an Ethernet interface for TRILL or a HiGig™ interface for communicating between different chips in a stack in an FE-fabric so that a virtual switch or other network entity having different port densities can be provided.

The applications 250 improve the response time and latency of forwarded packet data. The primary applications are implemented at the application layer 214 of the control element 18A. For example, the applications 250 may include a link aggregation control protocol (LADP), or ping application, or other application that handles the processing of incoming requests such as a ping request or an ARP request via local network ports.

The master control element 18A can include a network interface controller (NIC) 202, a Linux kernel 204, an MDT layer 206, an MTL layer 208, a DC layer 210, a checkpoint (CP) layer 212, and one or more application layer 214. The backup control element 18B can include some or all of these elements.

The NIC 202 can include an Ethernet interface or other interface that permits the control element 18 to be coupled to a network 14 for communicating with one or more forwarding elements 16, for example, to receive data packets from forwarding elements 16A, 16B. Additional details of the NIC 202 are known to those of ordinary skill in the art, and are omitted herein for reasons related to brevity. Details of the Linux kernel 204 are likewise known to those of ordinary skill in the art, and are omitted herein for reasons related to brevity.

The MDT layer 206 is similar to the MDT layer 246 of the forwarding elements 16A and 16B. Details of the MDT layer 206 are therefore omitted for brevity. However, the MDT layer 206 and the MDT layer 246 can perform different actions, depending on whether they are configured as a master, a backup, or a member. For example, the MDT layer 206 can include an RPC mechanism, including an RPC client configured at the master control element 18A and an RPC server configured at the MDT layer 246 of a member, i.e. a forwarding element 16.

The MTL layer 208 tracks and maintains membership information pertaining to a stack, for example, members of a stack including the forwarding elements 16 and the control elements 18. Other information can include switch information, such as MAC address, time when packets are received, and the like. A switch can maintain this received information at the MTL layer 208, which can include a database for storing this information. This information can be provided from the MDT layer 206, and output to the DC layer 210, for example, of the master control element 18A, for stack coordination and formation. The MTL layer 208 can glue the member reporting portion of the MDT layer 206 to the DC layer 210. In other words, the MDT layer 206 can report to the local DC layer 210 all the switch information it has discovered thus far through a JOIN_STACK message and/or a LEAVE_STACK message.

During an operation, one or more forwarding elements 16 can send changes to information related to switch changes, e.g., configuration changes, to the MTL layer 208 of the control element 18A for tracking purposes and the like. The MTL layer 208 can also perform an election of a stack master, for example, the master control element 18A.

The DC layer 210 receives packet data from a DC layer 248 of one or more forwarding elements 16 and can service the communication required by the master control element 18A to control operations related to the forwarding elements 16.

The CP layer 212 services the communication in between the master control element 18A and the backup control element 18B. In particular, the CP layer 212 can synchronize applications in the application layer 214 on the master control element 18A with the backup control element 18B. The CP layer 212 can further synchronize database states (not shown) between the master control element 18A with the backup control element 18B for redundancy and/or high availability, and to facilitate a master failover in the event that such a failover is required.

The application layer 214 includes applications related to configuration, port management, packet processing, and related features. The application layer 214 can include a user interface for providing a global view of the ports of the forwarding elements 16, for example, configured as switches in a stack. The application layer 214 can include a command line interface (CLI) or related interface. Users can configure the switches in a stack via the CLI. In an embodiment, the application layer 214 run on the master control element 18A and/or the backup control element 18B. In other embodiments, different applications can run on different control elements.

As shown in FIG. 2, the control features of a network switch are physically separate from the forwarding features, which can be beneficial when the port density of the switch increases to a such a degree that a more powerful controller is required. To achieve this, the DC layer and the modules thereon, for example, the CP layer 212 and application 212 can run on a control element 18, while layers below the DC layer, including DC layer itself, can run on a forwarding element 16.

The master control element 18A can communicate with the backup control element 18B by exchanging data via the CP layer 212, the DC layer 210, and/or the MDT layer 206. The MDT layer 206 of the master control element 18A can communicate with the MDT layer 206 of the backup control element 18B to provide member discovery and reporting data, for example, described herein. The CP layer 212 can synchronize applications, database states, and so on, between the master control element 18A and the backup control element 18B.

The DC layer 210 of the master control element 18A can communicate with the DC layer 210 of the backup control element 18B to provide device configuration data, for example, a route table and a host table for layer 3 configurations.

During an operation, each forwarding element can perform SDK initialization for its own local chips 242. However, control element 18A and 18B do not perform an SDK initialization if no forwarding element features or functions are present on the local device, i.e. the control element server, since the control elements 18 do not include chips for data packet forwarding.

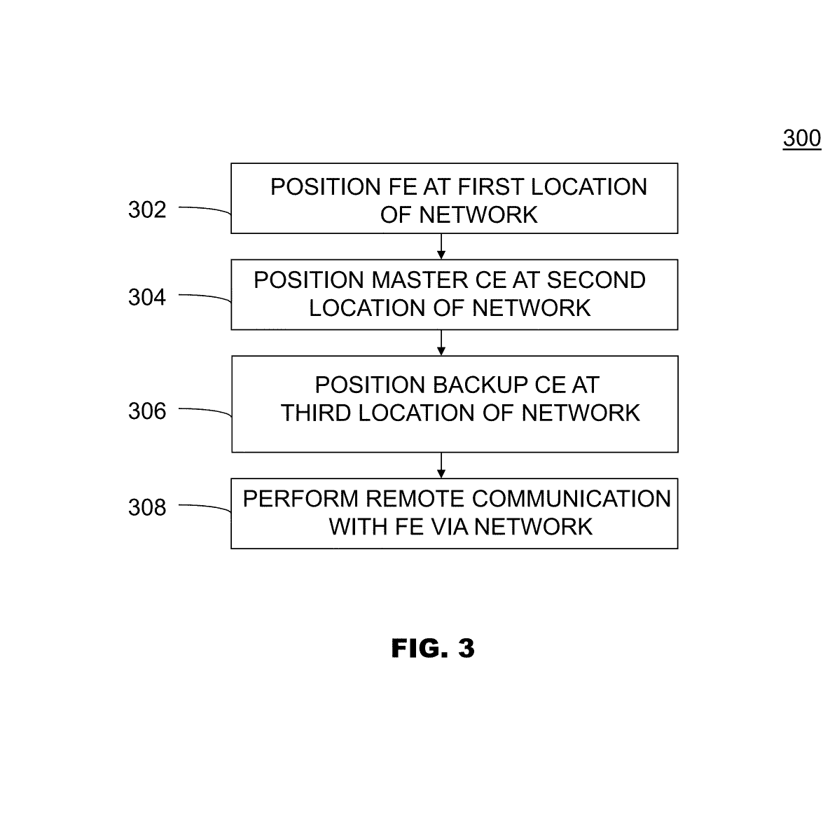

FIG. 3 is a flowchart of a method 300 for providing a remote control plane for a distributed switch, in accordance with an embodiment. In describing the method 300, reference is also made to elements of FIGS. 1 and 2. Certain steps of the method 300 can be performed on a server or other computer system having at least a processor, a memory, a network interface, and at least one control element 18. Other steps of the method 300 can be performed on a network switch, router, or other data forwarding device comprising at least a processor, a memory, one or more data ports, and at least one forwarding element 16.

At step 302, a forwarding element 16 is positioned at a first location of a network switch. In an embodiment, the network switch is a distributed virtual switch. The forwarding element 16 includes a plurality of network ports for transmitting and receiving data.

At step 304, a master control element 18A is positioned at a second location of the distributed switch. The master control element 18A can run on a computer platform that is remote from the forwarding element 16. In the event that additional physical and/or virtual ports are added to the forwarding element 16, the master control element 18A can be configured on a different computer platform having a more powerful CPU, a multi-core processor, or other performance-enhancing computer for accommodating the additional ports. The master control element 18A is connected to a same network as the forwarding element 16, for example, an Ethernet network configured as a L2 VLAN.

At step 306, a backup control element 18B is positioned at a third location of the distributed switch. The backup control element 18B can run on a computer platform that is remote from the forwarding element 16 and the master control element 18A. The backup control element 18B is connected to a same network as the forwarding element 16 and the master control element 18A, for example, an Ethernet network configured as a L2 VLAN.

At step 308, the master control element 18A and/or the backup control element 18B communicates with the forwarding element 16, and with each other, via the network 14. An example of a communication is the MDT layer 206 of the master control element 16A exchanging member discovery and reporting data with the MDT layer 246 of the forwarding element 16. The master control element 18A can therefore output information related to collected switch data. The MDT layer 206 includes an EL2T protocol to facilitate communications between the MDT layers 206 and 246, and layers above the DC layers 210, 248 for example, between the DC layers 210 and 248. The EL2T protocol can also facilitate an exchange of application data 214 between the master control element 16A and the backup control element 16B via the CP layer 212.

The DC layer 210 of the master control element 18A establishes control of the forwarding element 16 via the DC layer 248 of the forwarding element 16. In addition, the master control element 18A and the backup control element 18B communicate with each other via the network 14. The backup control element 18B can provide redundancy to the network switch by exchanging data via the MDT layers 206, the DC layers 210, and the CP layers 212 of the master control element 18A and the backup control element 18B, respectively. In an embodiment, the network 14 when configured as an Ethernet network provides jumbo frame support so that protocol control packets can be output, e.g., tunneled, from the forwarding element 16 to the master control element 18A according to a MAC-in-MAC format.

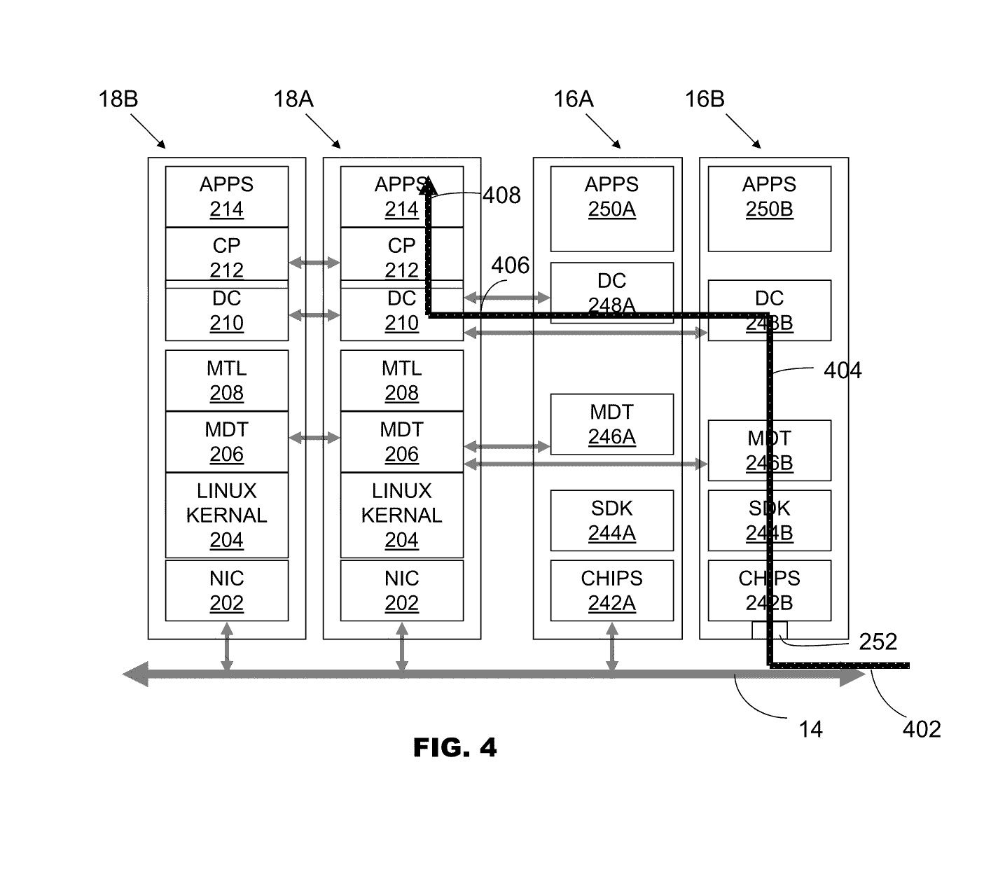

FIG. 4 is a block diagram of the control elements and the forwarding elements of FIGS. 1 and 2 illustrating a data flow path formed between components of the control elements and the forwarding elements, in accordance with an embodiment. One or more data packets can be provided to the master control element 18A from a forwarding element 16B via the data flow path. The data flow path can be formed according to the method 300 described herein.

A first portion 402 of the data flow path is at a region where data packet is received via a port 252 at a forwarding element 16B. A second portion 404 of the data flow path is at a region between the port 252 and the DC layer 248B of the forwarding element 16B. For example, the MDT layer 246B can receive switch detection events related to the forwarding elements 16, and output the events to the DC layer 248B along the second portion 404. An EL2T layer (not shown) can be configured at the forwarding elements 16 and the control elements 18 to facilitate a communication between them, for example, redirecting a protocol control packet from a network port at a forwarding element 16 to the control element 18A for processing, for example, shown in FIG. 4.

The DC layer 248B in turn outputs the data packets along a third portion 406 of the data flow path to a DC layer 210 at the master control element 18A. Data packets are directed to the control element 18a by being tunneled via the DC layers 210, 248B. Ingress and/or egress port information is included in the data packets.

The DC layer 210 of the master control element 18A outputs the data packets along a fourth portion 408 of the data flow path to the application layer 214, which can include, for example, applications related to the spanning tree protocol (STP), open shortest path first (OSPF) protocol, and the like for processing the data packets.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific embodiments, it should be understood by those skilled in the art that various changes in form and detail may be made therein without departing from the spirit and scope of the invention.

What is claimed is:

1. A method for controlling a network switch, comprising:
positioning at least one forwarding element of a distributed switch at a first location of a network;
positioning a control element of the distributed switch at a second location of the network; and
controlling the at least one forwarding element from the control element by establishing a communication between the forwarding element and the control element via the network.

2. The method of claim 1, wherein establishing the communication between the at least one forwarding element and the control element includes configuring the at least one forwarding element and the control element with a device configuration (DC) layer and a member discovery and transport (MDT) layer, the DC layer of the at least one forwarding element communicating with the DC layer of the control element, and the MDT layer of the at least one forwarding element communicating with the MDT layer of the control element.

3. The method of claim 2, wherein the DC layer of the control element services the communication needed for the control element to control the operation of the at least one forwarding element.

4. The method of claim 2, further comprising forming a data path between the at least one forwarding element and the control element by tunneling data packets between the DC layer of the at least one forwarding element communicating with the DC layer of the control element.

5. The method of claim 2, wherein the MDT layer provides member discovery and reporting.

6. The method of claim 1, wherein the control element includes a master control element and a backup control element for redundancy.

7. The method of claim 6, wherein establishing a communication between the master control element and the backup control element includes configuring each of the master control element and the backup control element with a check point module (CP) that services the communication in between the master control element and the backup control element for synchronization of database and application states from control element-Master to control element-Backup to facilitate the need for master failover.

8. The method of claim 6, wherein the master control element is positioned at the second location and the backup control element is positioned at a third location of the network.

9. The method of claim 1, wherein the distributed switch includes a distributed virtual switching chassis.

10. The method of claim 1, wherein the distributed switch includes a cell-based switch.

11. The method of claim 1, wherein the network is an L2 VLAN connected to the at least one forwarding element and the control element.

12. A network switch, comprising:
a forwarding element connected to a network, the forwarding element receiving and forwarding data packets via the network; and
a control element at a physically separate location from the forwarding element and in communication with the forwarding element via the network, the control element controlling the forwarding element via communication path between the control element and the forwarding element via the network.

13. The network switch of claim 12, wherein the forwarding element and the control element are part of a distributed switch.

14. The network switch of claim 12, wherein the network is an L2 VLAN, and wherein the forwarding element and the control element are members of the L2 VLAN.

15. The network switch of claim 12, wherein the control element includes an MDT layer, a DC layer and an application layer.

16. The network switch of claim 15, wherein the forwarding element includes an MDT layer that communicates with the MDT layer of the control element, and a DC layer that communicates with the DC layer of the control element.

17. The network switch of claim 12, wherein the control element includes a master control element and a backup control element.

18. The network switch of claim 17, wherein the master control element and a backup control element each includes a CP layer for communicating with each other.

19. A method of remotely controlling a forwarding element of a network switch, comprising:
receiving a data packet at a data port of the forwarding element;
outputting the data packet to a DC layer of the forwarding element;
outputting the data packet from the DC layer of the forwarding element to the DC layer of a control element at a remote server; and
outputting the data packet from the DC layer of the control element to an application layer at the control element.

20. A computer program product for controlling a network switch, the computer program product comprising:
a computer readable storage medium having computer readable program code embodied therewith, the computer readable program code comprising;
computer readable program code configured to provide at least one forwarding element of the distributed switch at a first location of a network;
computer readable program code configured to provide a control element of the distributed switch at a second location of the network; and
computer readable program code configured to control the at least one forwarding element from the control element by establishing a communication between the forwarding element and the control element via the network.
